(19) United States
(12) Patent Application Publication
(10) Pub. No.: US 2020/0348131 A1
(43) Pub. Date: Nov. 5, 2020

(54) METHOD OF DIAGNOSING PIPE, DEVICE OF DIAGNOSING PIPE, AND SYSTEM OF DIAGNOSING PIPE

(71) Applicant: FUJITSU LIMITED, Kawasaki-shi (JP)

(72) Inventors: Jun Taniguchi, Isehara (JP); Takeshi Soeda, Kawasaki (JP); YOICHI TAKASU, Isehara (JP)

(73) Assignee: FUJITSU LIMITED, Kawasaki-shi (JP)

(21) Appl. No.: 16/932,889

(22) Filed: Jul. 20, 2020

Related U.S. Application Data
(63) Continuation of application No. PCT/JP2018/007483, filed on Feb. 28, 2018.

(51) Int. Cl. G01B 21/08; F17D 3/01; G01N 25/18

(52) U.S. Cl. CPC G01B 21/08; G01N 25/18; F17D 3/01

(57) ABSTRACT

A method of diagnosing a pipe includes diagnosing, by a computer, a state of a pipe from an updated model based on change in temperature of the pipe calculated from the model in a case where the pipe is heated in the model obtained by modeling a heat transfer behavior of an inside of the pipe containing deposition by using an equivalent circuit and change in temperature of the pipe measured in a case where the pipe is heated.

### CROSS-REFERENCE TO RELATED APPLICATION

This application is a continuation application of International Application PCT/JP2018/007483 filed on Feb. 28, 2018 and designated the U.S., the entire contents of which are incorporated herein by reference.

### FIELD

The present embodiment discussed herein is related to a method of diagnosing a pipe, a device of diagnosing a pipe, and a system of diagnosing a pipe.

### BACKGROUND

A thinning state of a pipe installed in, for example, a building and a factory is predicted.

Japanese Laid-open Patent Publication No. 2006-284416 is disclosed as related art.

### SUMMARY

According to an aspect of the embodiments, a method of diagnosing a pipe includes diagnosing, by a computer, a state of a pipe from an updated model based on change in temperature of the pipe calculated from the model in a case where the pipe is heated in the model obtained by modeling a heat transfer behavior of an inside of the pipe containing deposition by using an equivalent circuit and change in temperature of the pipe measured in a case where the pipe is heated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 schematically illustrates a system of diagnosing a pipe according to one embodiment;

FIG. 2 illustrates one example of the hardware configuration of an information processing device;

FIG. 3 is a functional block diagram of the information processing device;

FIG. 4A is a cross-sectional view illustrating one example of a thinned pipe in which deposition is deposited;

FIG. 4B illustrates an equivalent circuit obtained by modeling the heat transfer behavior of the pipe illustrated in FIG. 4A;

FIG. 4C illustrates sections represented by each element illustrated in FIG. 46;

FIG. 5A is a cross-sectional view illustrating another example of a thinned pipe in which deposition is deposited;

FIG. 5B illustrates an equivalent circuit obtained by modeling the heat transfer behavior of the pipe illustrated in FIG. 5A;

FIG. 5C illustrates sections represented by each element illustrated in FIG. 5B;

FIG. 6 is a flowchart of pipe diagnosing processing executed by the information processing device;

FIG. 7A illustrates the processing of Step S21 in FIG. 6;

FIG. 7B illustrates the processing of Step S23 in FIG. 6;

FIG. 8 illustrates the processing of Step S25 in FIG. 6; and

FIG. 9 schematically illustrates a variation of the system of diagnosing a pipe.

### DESCRIPTION OF EMBODIMENTS

For example, a temperature sensor detects temperature of a pipe at the time when a heater heats the pipe and then the pipe is cooled. The thinning state of the pipe is predicted based on the change in temperature. Unfortunately, for example, when deposition is deposited in the pipe, temperature change similar to that in the state where the pipe is not thinned may be detected in spite of the fact that the pipe is thinned. Prediction accuracy may be insufficient.

In one aspect, a method of diagnosing a pipe, a device of diagnosing a pipe, and a system of diagnosing a pipe, which are capable of diagnosing the state of the pipe with high accuracy, may be provided.

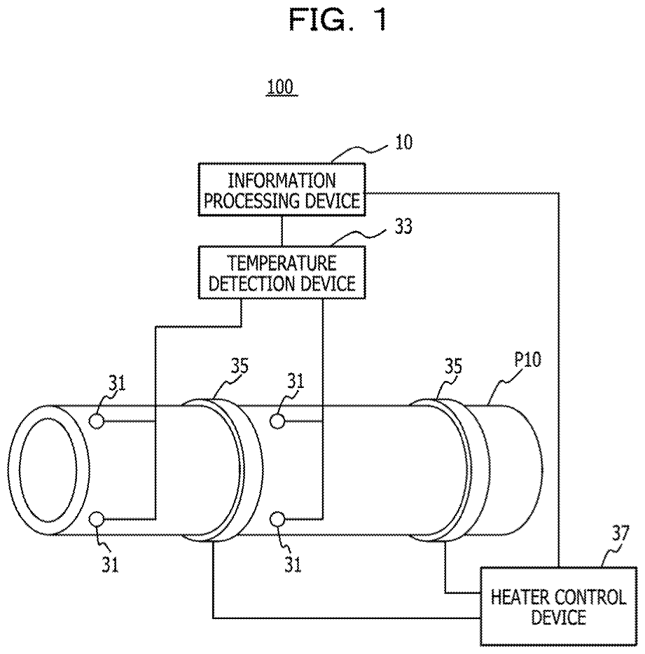

Hereinafter, a system of diagnosing a pipe according to one embodiment will be described in detail with reference to FIGS. 1 to 8.

FIG. 1 schematically illustrates the configuration of a system 100 of diagnosing a pipe according to one embodiment. As illustrated in FIG. 1, the system 100 of diagnosing a pipe includes a temperature sensor 31, a temperature detection device 33, a heater 35, a heater control device 37, and an information processing device 10. The temperature sensor 31 and the temperature detection device 33 function as measurement devices. The heater functions as a heating device. The information processing device 10 functions as a device of diagnosing a pipe.

The system 100 of diagnosing a pipe is a device for diagnosing the state of a pipe P10 by using a model. The accuracy of the model is enhanced by comparing change in temperature of the pipe P10 calculated from a model in the case where the heater 35 heats the pipe P10 with measured change in temperature of the pipe. The model is obtained by modeling the heat transfer behavior of the inside of the pipe P10 containing deposition by using an equivalent circuit. For example, the system 100 of diagnosing a pipe periodically changes output of the heater 35, and makes a predetermined parameter derived from periodic change in surface temperature of the pipe P10 In the case where periodic change in temperature is given to the pipe P10 approximate a predetermined parameter derived from the measured periodic change in surface temperature of the pipe P10. The system 100 of diagnosing a pipe then obtains a model matching the actual state of the pipe. The system 100 of diagnosing a pipe determines a thinning risk from the model.

The temperature sensor 31 is disposed on the surface of the pipe P10 so as to measure a surface temperature of the pipe P10 at a point separated from the heater 35 by a predetermined distance in a length direction of the pipe. An output signal of the temperature sensor 31 is input to the temperature detection device 33. The temperature detection device 33 detects a temperature of the pipe P10 from the output signal of the temperature sensor 31, and outputs the detection result to the information processing device 10. The distance between the temperature sensor 31 and the heater 35 may be appropriately set in consideration of, for example, the performance of the heater and the thickness of the pipe P10. Furthermore, one or a plurality of temperature sensors 31 may be provided.

The heater control device 37 periodically changes the output of the heater 35 based on the output and frequency f set by the later-described information processing device 10. The heater 35 periodically heats the pipe P10 at the frequency f under the control of the heater control device 37.

The information processing device 10 receives input of data on an equivalent circuit (model) obtained by modeling the heat transfer behavior of the pipe P10, the shape of the pipe P10, the shape of the heater 35, the type of fluid flowing through the pipe P10, the pressure of the fluid, the flow rate of the fluid, and outside air temperature. Note that a sensor (not illustrated) installed on the pipe P10 inputs the pressure of the fluid, the flow rate of the fluid, and the outside air temperature to the information processing device 10.

The information processing device 10 decides the output of the heater 35 and the frequency f based on the received model and various pieces of data, and sets the output and the frequency f to the heater control device 37. Note that the information processing device 10 may display the decided output and frequency f on, for example, a display 119 of the information processing device 10. A user who has confirmed the display may set the output and the frequency f to the heater control device 37.

When the pipe P10 is periodically heated at the output and the frequency f of the heater 35 decided by the information processing device 10, the information processing device 10 calculates the thickness of the deposition inside the pipe P10 and the thickness of the pipe P10, updates the model, and obtains a model matching the actual state of the pipe based on periodic change in surface temperature of the pipe P10 calculated from the model of heat transfer behavior of the pipe P10 and actually measured periodic change in surface temperature of the pipe P10. Then, the information processing device determines the thinning risk of the pipe P10 by using the updated model. Furthermore, the information processing device 10 announces information on ultrasonic diagnosis for the pipe P10 and information on cleaning for the pipe P10 based on the determination result of the thinning risk.

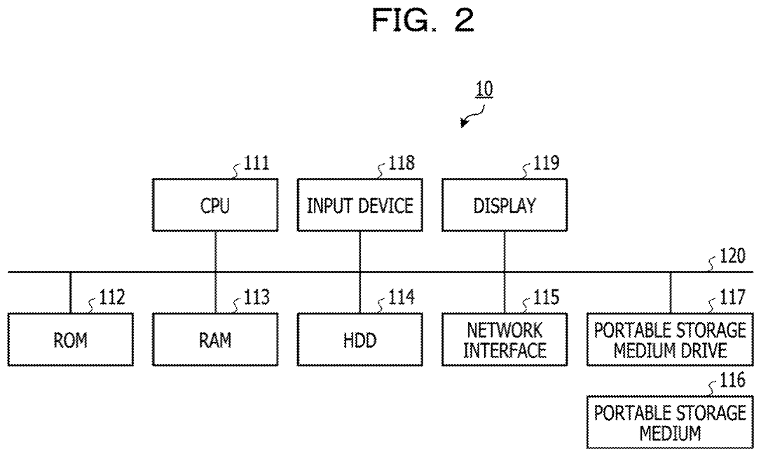

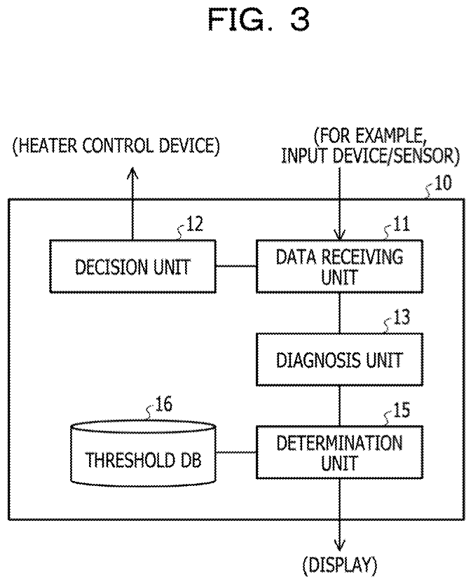

The information processing device 10 has the hardware configuration as illustrated in FIG. 2. For example, as illustrated in FIG. 2, the information processing device 10 includes a central processing unit (CPU) 111, a read only memory (ROM) 112, a random access memory (RAM) 113, a storage device (hard disk drive (HDD)) 114, a network interface 115, a portable storage medium drive 117 capable of reading data stored in a portable storage medium 116, an input device 118, the display 119, and the like. Each component of the information processing device 10 is connected to a bus 120. The input device 118 is, for example, a keyboard, a mouse, a touch panel, and the like, but is not limited thereto. The CPU 111 causes the information processing device 10 to function as each unit in FIG. 3 by executing a program stored in the ROM 112 or the HDD 114, or a program read by the portable storage medium drive 117 from the portable storage medium 116.

For example, as illustrated in FIG. 3, the information processing device 10 functions as a data receiving unit 11, a decision unit 12, a diagnosis unit 13, and a determination unit 15 by the CPU 111 executing a program. The determination unit 15 functions as a determination unit and an announcement unit.

The data receiving unit 11 receives input of an equivalent circuit (model) obtained by modeling the heat transfer behavior of the pipe P10 from a user via, for example, the input device 118. Here, the equivalent circuit obtained by modeling the heat transfer behavior of the pipe P10 will be described.

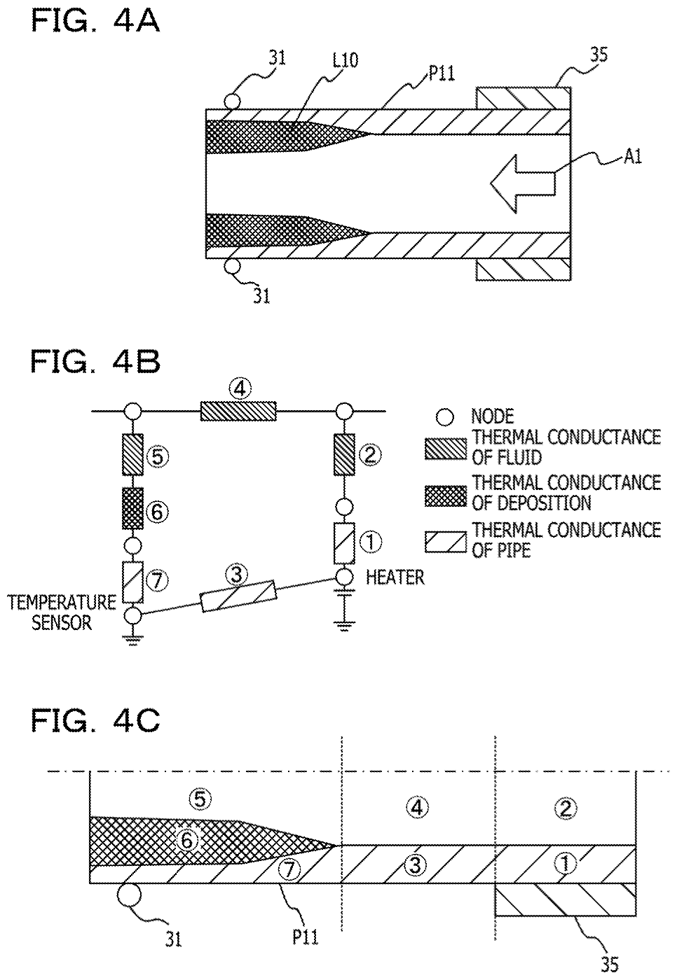

FIG. 4A is a cross-sectional view illustrating one example of a thinned pipe in which deposition is deposited. Fluid flows inside a pipe P11 in the direction indicated by an arrow A1. The heater 35 is attached on the upstream side of the pipe P11. The temperature sensor 31 is attached on the downstream side. Deposition L10 is deposited on the downstream side of the pipe P11.

For example, FIG. 4B illustrates an equivalent circuit. The equivalent circuit illustrates a heat transfer path through which heat from the heater 35 is transmitted to the temperature sensor 31 via fluid flowing through the pipe P11 and the pipe P11 in FIG. 4A. Here, the model in FIG. 4B is obtained by modeling the lower half of the pipe P11 as illustrated in FIG. 4C. The model includes elements representing thermal conductances of the fluid flowing inside the pipe P11, the deposition deposited inside the pipe P11, and the pipe P11. The number adjacent to each element in FIG. 46 represents each section in FIG. 4C in which each element is modeled.

Here, the thermal conductance of the pipe P11, the thermal conductance of the deposition L10, and the thermal conductance of the fluid can be determined by Expression (1) below.

[Math 1]

G=λA/L (1)

Here, G represents thermal conductance, λ represents thermal conductivity, λ represents area, and L represents length (or thickness).

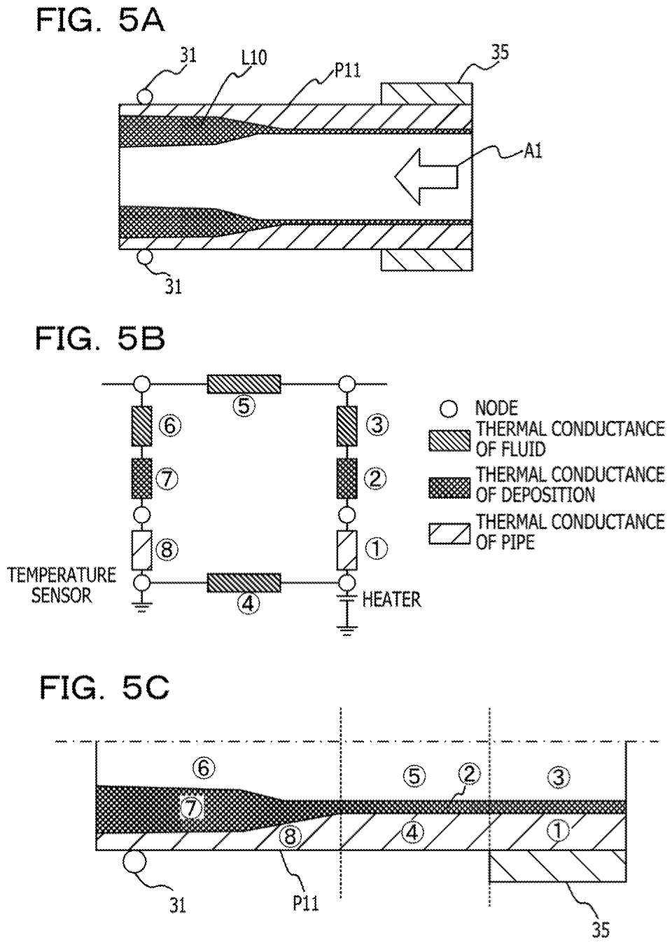

Note that, when the deposition L10 is deposited also at the place where the heater 35 is installed as illustrated in FIG. 5A, an element representing the thermal conductance of the deposition L10 is added to the place in the equivalent circuit in FIG. 4B. The equivalent circuit in FIG. 4B is corrected to the equivalent circuit as illustrated in FIG. 58. The model does not need to be created every time. A model created for a pipe can be used for a pipe having equivalent irregularities, bends, and the like. Moreover, the model is preferably registered as a database in a storage device such as the HDD 114.

Returning to FIG. 3, the data receiving unit 11 receives input of data on the physical property of a pipe from a user via the input device 118. For example, the data receiving unit 11 receives inputs of the shape of the pipe, the shape of the heater 35, and the type of fluid flowing through the pipe from the user. Furthermore, the data receiving unit 11 receives inputs of the pressure of the fluid, the flow rate of the fluid, and the outside air temperature from various sensors (not illustrated) installed on the pipe. The data receiving unit 11 outputs the received model and various pieces of data to the decision unit 12 and the diagnosis unit 13. Furthermore, the data receiving unit 11 receives the data on the surface temperature of the pipe measured by the temperature sensor 31 from the temperature detection device 33, and outputs the data to the diagnosis unit 13.

The decision unit 12 decides the output of the heater 35 and the frequency f based on the received model and various pieces of data, and sets the output and the frequency f to the heater control device 37.

The diagnosis unit 13 inputs various pieces of data to a model obtained by modeling the heat transfer behavior of a pipe, and analyzes a thermal circuit network. The diagnosis unit 13 calculates a thickness Ld of deposition inside a pipe based on the delay time between the time at the peak value in a cycle of change in the surface temperature of the pipe calculated from the model in the case where the pipe is periodically heated and the time at the peak value in a cycle of change in the surface temperature of the pipe measured by the temperature sensor 31.

Moreover, the diagnosis unit 13 calculates a thickness Lp of the pipe based on the peak value of the surface temperature of the pipe determined from the model in the case where the thickness of the deposition is Ld and the peak value of the actual surface temperature of the pipe measured by the temperature sensor 31. The diagnosis unit 13 outputs the calculated thickness Ld of the deposition and thickness Lp of the pipe to the determination unit 15.

The determination unit 15 calculates the thermal conductance of the pipe in the model in the case where the thickness of the deposition is Ld and the thickness of the pipe is Lp. The determination unit 15 determines whether there is a thinning risk by comparing a threshold registered in a threshold DB 16 and the calculated thermal conductance. A threshold, which was determined in the past based on the thermal conductance of a pipe at the time of pipe replacement in another similar pipe system, is stored in the threshold DB 16. For example, when the calculated thermal conductance is equal to or greater than the threshold, the determination unit 15 determines that there is a thinning risk (pipe is highly likely to be thinned enough to need pipe replacement). For example, when determining that there is a thinning risk, the determination unit announces information on ultrasonic diagnosis. Otherwise, the determination unit 15 announces information on pipe cleaning.

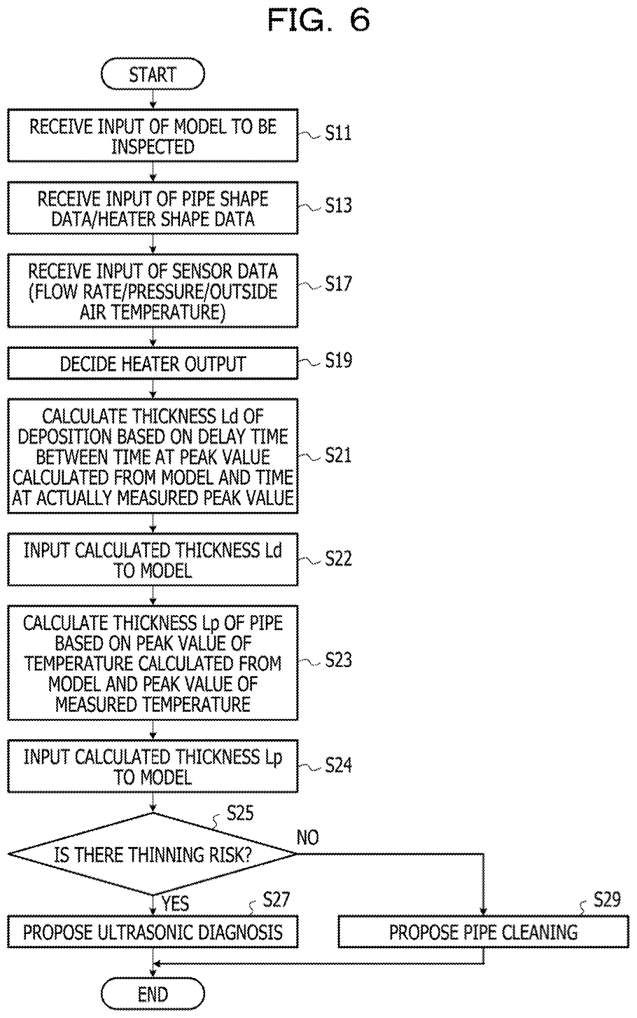

Next, one example of pipe diagnosing processing executed by the information processing device 10 will be described. FIG. 6 is a flowchart illustrating one example of the pipe diagnosing processing executed by the Information processing device 10. The processing in FIG. 6 is executed regularly (every 6 months), for example. Note that the processing in FIG. 6 may be executed, for example, at the timing designated by a manager of piping facility. In the following description, an example of a case where a pipe system A is diagnosed will be described. Six years has passed since a previous pipe replacement. The pipe system A has a pipe having an outer diameter of 100 mm and an initial thickness of 5 mm. The flow velocity, measured by a flow-rate sensor, of water flowing inside the pipe is 2 m/s. Furthermore, it is assumed that water flowing inside the pipe has uniform flow-velocity distribution and fixed flow velocity. It is assumed that heats of the pipe and deposition fixedly transmit.

In the processing in FIG. 6, first, the data receiving unit 11 receives input of a model obtained by modeling the heat transfer behavior of a pipe to be inspected (Step S11).

Next, the data receiving unit 11 receives inputs of pipe shape data and heater shape data (Step S13). Furthermore, the data receiving unit 11 receives input of sensor data (flow rate/pressure/outside air temperature) (Step S17).

Next, the decision unit 12 decides the output and cycle of the heater 35 (Step S19). For example, the decision unit 12 decides the cycle of the heating cycle of the heater 35 as 6,000 seconds. The heater 35 starts to periodically heat the pipe with the decided output and cycle.

Next, the diagnosis unit 13 calculates a thickness Ld of deposition in an element representing the thermal conductance of the deposition in a model based on the delay time between the time at the peak value in a cycle of change in the surface temperature of the pipe calculated from the heating cycle of the pipe and the model and the time at the peak value in a cycle of change in the measured surface temperature of the pipe (Step S21). For example, the diagnosis unit 13 assumes the thickness Lp of the pipe as an initial thickness of 5 mm, and changes the thickness Ld of deposition. The diagnosis unit 13 calculates the thickness Ld of the deposition with which the delay time between the model and the actual measurement is minimized. When deposition is deposited inside the pipe, heat slowly transmits from fluid flowing inside the pipe to the temperature sensor 31, and the peak in the heating cycle of the pipe is delayed. Consequently, the delay time can be used to calculate the thickness Ld of the deposition inside the pipe.

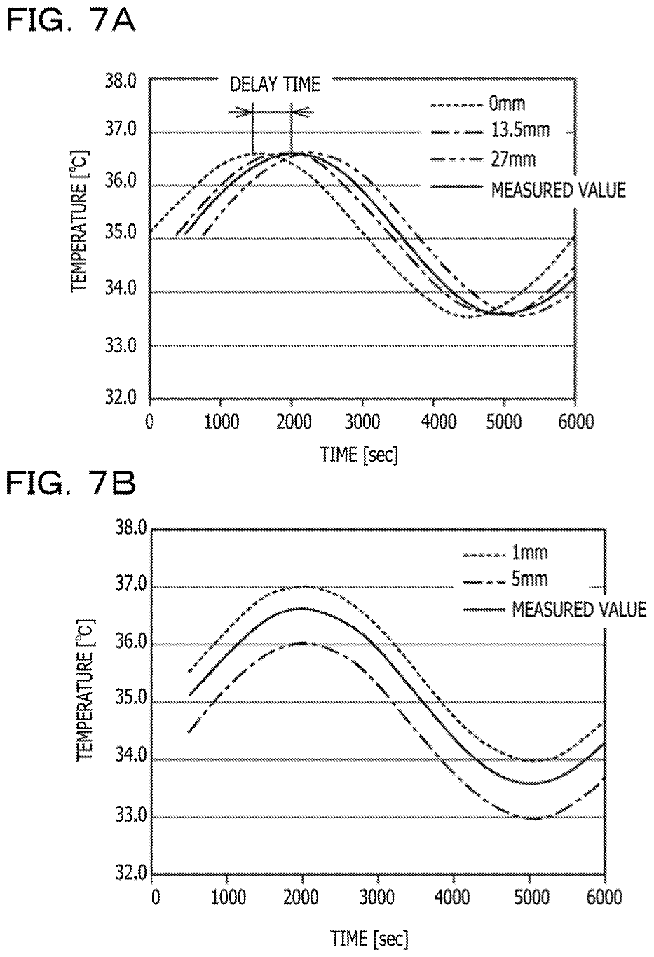

For example, the diagnosis unit 13 calculates the delay time between the time at the peak value in a cycle of temperature change in the surface temperature of the pipe and the time at the peak value in a cycle of actually measured temperature change in the case of the thicknesses of deposition of 0 mm, 13.5 mm, and 27 mm in the model. The diagnosis unit 13 calculates the thickness Ld of deposition with which the delay time between the time at the peak value calculated from the model and the actually measured time at the peak value is minimized. For example, as illustrated in FIG. 7A, the times at the peak values calculated from the model in the case of assuming the thickness of deposition as 0 mm, 13.5 mm, and 27 mm are assumed as 1,500 seconds, 1,875 seconds, and 2,250 seconds, respectively. In the case, when the actually measured time at the peak value is 2,000 seconds, the diagnosis unit 13 calculates the thickness Ld of deposition as 18 mm. Since the thickness Ld of the deposition is calculated based on the actually measured value, the thickness Ld can be calculated with high accuracy.

Note that, instead of the thickness of the deposition, a temperature waveform of the surface temperature of the pipe may be calculated with respect to the dogging rate of the pipe. For example, in the case of a pipe having an outer diameter of 100 mm and an initial thickness of 5 mm, the dogging rate is 30% when the deposition has a thickness of 13.5 mm, and the clogging rate is 60% when the deposition has a thickness of 27 mm.

Returning to FIG. 6, the diagnosis unit 13 inputs the thickness Ld of the deposition calculated in Step S21 to the model, and updates the model (Step S22). As a result, the state of the deposition actually deposited inside the pipe is reflected in the model. For example, the model is updated to a model that matches the actual pipe state, and thus the accuracy of the model is improved.

Next, the diagnosis unit 13 calculates the thickness Lp of the pipe in a pipe in an element representing the thermal conductance of the pipe in the model based on the peak value of the surface temperature of the pipe calculated from the model to which the thickness Ld is input (reflected) and the peak value of the actual measured surface temperature of the pipe (Step S23). For example, the diagnosis unit 13 changes the thickness Lp of the pipe, and calculates the thickness Lp of the pipe with which the difference between the peak value calculated from the model and the actually measured peak value is minimized. As the pipe gets thicker, heat from the heater 35 more diffuses, and the peak value of the surface temperature of the pipe is reduced. The peak value of the surface temperature of the pipe can thus be used to calculate the thickness Lp of the pipe.

For example, the diagnosis unit 13 calculates the peak value of the surface temperature of the pipe in the case of the thickness Lp of the pipe of 1 mm and 5 mm in the model to which the thickness Ld of the deposition calculated in Step S21 is input. Then, the diagnosis unit 13 calculates the thickness Lp of the pipe with which the difference between the peak value calculated from the model and the peak value of the actual measured surface temperature of the pipe is minimized. For example, as illustrated in FIG. 7B, it is assumed that the peak values of the surface temperature of the pipe calculated from the model in the case of the thickness Lp of the pipe of 1 mm and 5 mm are 37.0° C. and 36.0° C., respectively. In the case, when the peak value of the actually measured surface temperature of the pipe is 36.6° C., the diagnosis unit 13 calculates the thickness Lp of the pipe as approximately 3 mm. Since the thickness Lp of the pipe is calculated based on the actually measured value, the thickness Lp can be calculated with high accuracy.

Returning to FIG. 6, the diagnosis unit 13 inputs the thickness Lp of the pipe calculated in Step S23 to the model, and updates the model (Step S24). As a result, the actual thinning state of the pipe is reflected in the model. For example, the model is updated to a model that matches the actual pipe state, and thus the accuracy of the model is improved.

Note that, in Steps S21 and S23, it is assumed in the model that fluid flowing in the pipe has a uniform flow-velocity distribution and a fixed flow velocity, and that heats of the pipe and deposition fixedly transmit. Thus, the calculation result from the model may include an error. Consequently, it is preferable to conduct an experiment at the initial stage of pipe installation, in which no deposition is deposited, and acquire data on the surface temperature of the pipe. The calculation accuracy can be improved by correcting the value calculated from the model based on the experimental data.

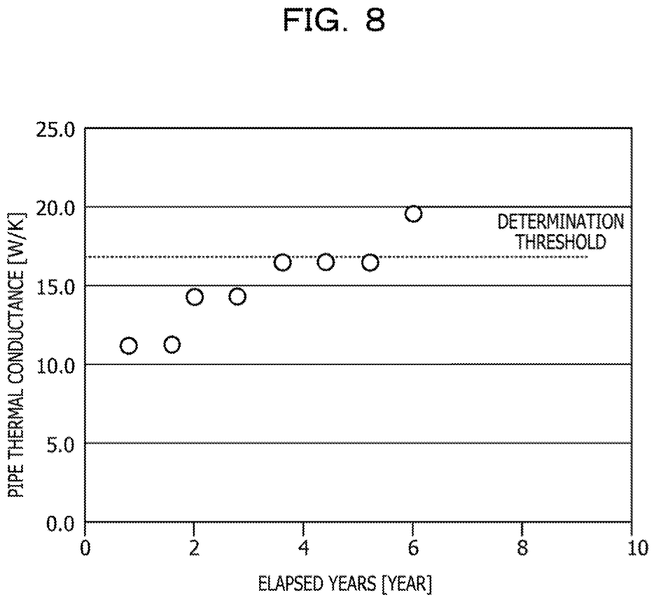

Next, the determination unit 15 determines whether there is a thinning risk (Step S25). For example, the thermal conductance of the pipe is calculated in the model in which the thickness Ld of the deposition and the thickness Lp of the pipe are input (reflected). When the calculated thermal conductance is equal to or greater than a threshold registered in the threshold DB 16, the determination unit 15 determines that there is a thinning risk. For example, as illustrated in FIG. 8, the thermal conductances of the pipe calculated when the pipe diagnosing processing is performed every half a year since the previous pipe replacement do not exceed a threshold of 17.0 W/K. When the thermal conductance of the pipe is calculated this time (six years has passed since pipe replacement), the thermal conductance exceeds the threshold of 17.0 W/K. In the case, the determination unit 15 determines that there is a thinning risk.

When determining that there is a thinning risk (Step S25/YES), the determination unit 15 announces information on ultrasonic diagnosis (Step S27), and ends the processing in FIG. 6. For example, the determination unit 15 displays a message recommending the execution of the ultrasonic diagnosis on the display 119 of the information processing device 10. This enables a user (e.g., manager of piping facility) to secure equipment and manpower needed for the ultrasonic diagnosis. In contrast, when determining that there is no thinning risk (Step S25/NO), the determination unit 15 announces information on pipe cleaning (Step S29), and ends the processing in FIG. 6. For example, the determination unit 15 displays a message recommending pipe cleaning on the display 119 of the information processing device 10. This enables the user to secure equipment and manpower needed for the pipe cleaning.

As described in detail above, according to the embodiment, the information processing device 10 includes the diagnosis unit 13. The diagnosis unit 13 diagnoses the state of a pipe from an updated model based on the change in temperature of the pipe calculated from the model in the case where the pipe is heated in the model obtained by modeling the heat transfer behavior of the inside of the pipe containing deposition by using an equivalent circuit and change in temperature of the pipe measured in the case where the pipe is heated. Since temperature change calculated from a model and the actually measured temperature change are used, the accuracy of the model is improved, and the accuracy of diagnosing the state of the pipe by using the model is also improved.

Furthermore, according to the embodiment, a model includes fluid flowing inside a pipe, deposition deposited inside the pipe, and an element representing the pipe. The diagnosis unit 13 calculates the state of the deposition deposited inside the pipe based on the delay time between the time at the peak value in a cycle of change in temperature of the pipe calculated from the model in the case where the pipe is periodically heated and the time at the peak value in a cycle of change in measured temperature of the pipe. The state of deposition (thickness of deposition) deposited in the pipe can be calculated by using the delay time between the model and the actual measurement. This improves the accuracy of the model, and also improves the accuracy of diagnosing the state of the pipe by using the model.

Furthermore, according to the embodiment, the diagnosis unit 13 updates the model based on the calculated state of deposition deposited in the pipe, and calculates the thinning state of the pipe based on the peak value of the surface temperature of the pipe calculated from the model in the case where the pipe is periodically heated and the peak value of the measured surface temperature of the pipe. The thinning state of the pipe (thickness of the pipe) can be calculated by using the peak value calculated from the model and the actually measured peak value. This improves the accuracy of the model, and also improves the accuracy of diagnosing the state of the pipe by using the model.

Furthermore, in the embodiment, the information processing device includes the determination unit 15. The determination unit 15 updates the model based on the calculated thinning state of the pipe, and determines a thinning risk based on a conductance value calculated from the updated model and a threshold determined based on the conductance value at the time of pipe replacement. A thinning risk is determined by comparison with a conductance value at the time of pipe replacement in the past, so that the thinning risk can be accurately determined.

Furthermore, in the present embodiment, the determination unit 15 of the information processing device 10 announces information on operation for a pipe based on the state of the diagnosed pipe. This enables a user of the information processing device 10 to assign an instrument and manpower needed for, for example, ultrasonic diagnosis and cleaning of the pipe.

Note that, in the above-described embodiment, the state of the pipe is calculated and reflected in the model based on periodic change in surface temperature of the pipe calculated from the model in the case where the pipe is periodically heated and periodic change in actually measured surface temperature of the pipe. For example, the state of the pipe may be calculated and reflected in the model based on change in surface temperature of the pipe calculated from the model at the time when the pipe is heated and then cooled and change in actually measured surface temperature of the pipe. In the case as well, the model can be made to match the actual state of the pipe by making a predetermined parameter value calculated from the model approximate an actually measured value.

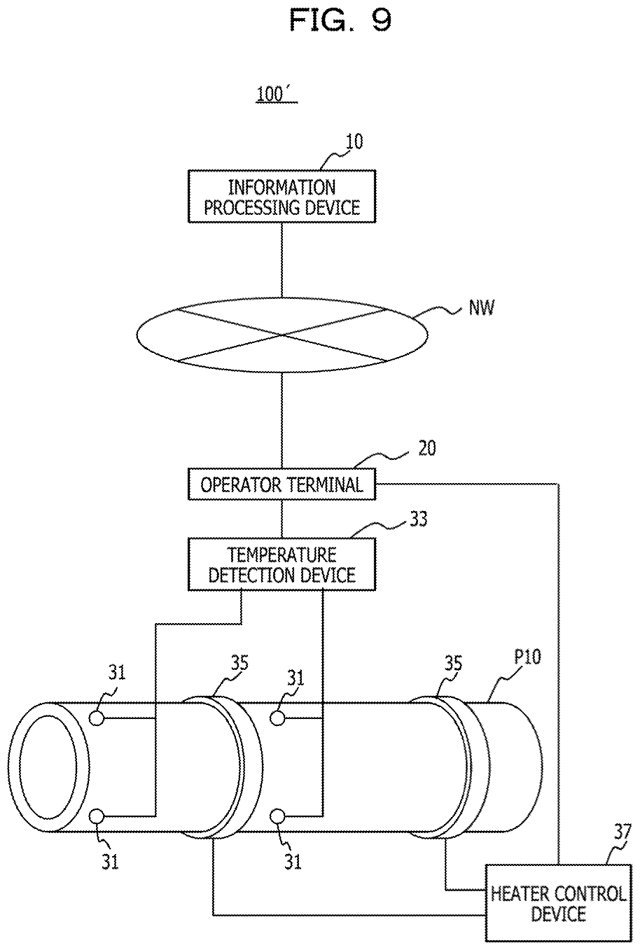

Note that, in the above-described embodiment, the information processing device 10 may be a cloud. An operator can diagnose a pipe by using service provided on the information processing device 10. The information processing device 10 is connected to an operator terminal 20 via a wired or wireless network NW, such as the Internet, a local area network (LAN), and a wide area network (WAN), as illustrated in FIG. 9.

Note that the above-described processing functions can be implemented by a computer. In that case, a program in which processing content of a function which a processing device preferably have is written is provided. The program is executed on the computer, whereby the above-described processing functions are implemented on the computer. The program in which the processing content is written can be recorded in a computer-readable reading medium (except carrier waves).

In the case of distributing the program, for example, the program is sold in a form of a portable storage medium such as a digital versatile disc (DVD) and a compact disc read only memory (CD-ROM) in which the program is recorded. Alternatively, a program can be stored in a storage device of a server computer. The program can be transferred from the server computer to another computer via a network.

A computer which executes the program stores, for example, a program recorded in the portable storage medium or a program transferred from the server computer in a storage device of the computer itself. Then, the computer reads the program from the storage device of the computer itself, and executes processing in accordance with the program. Note that the computer can also read the program directly from the portable storage medium, and execute processing in accordance with the program. Furthermore, the computer also can sequentially execute processing in accordance with the received program each time the program is transferred from the server computer.

The above-mentioned embodiment is a preferred example of carrying out the present embodiment. Note, however, that the embodiment is not limited to the preferred example. Various modifications can be made without departing from the gist of the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method of diagnosing a pipe comprising:
diagnosing, by a computer, a state of a pipe from an updated model based on change in temperature of the pipe calculated from the model in a case where the pipe is heated in the model obtained by modeling a heat transfer behavior of an inside of the pipe containing deposition by using an equivalent circuit and change in temperature of the pipe measured in a case where the pipe is heated.

2. The method according to claim 1
wherein the model includes fluid flowing inside the pipe, deposition deposited inside the pipe, and an element representing the pipe, and
the diagnosing a state of the pipe includes calculating a state of deposition deposited inside the pipe based on a delay time between a time at a peak value in a cycle of change in temperature of the pipe calculated from the model in a case where the pipe is periodically heated and a time at a peak value in a cycle of change in measured temperature of the pipe.

3. The method according to claim 2,
wherein the diagnosing a state of the pipe includes updating the model based on a calculated state of deposition deposited in the pipe, and calculating a thinning state of the pipe based on a peak value of surface temperature of the pipe calculated from the updated model in a case where the pipe is periodically heated and a peak value of measured surface temperature of the pipe.

4. The method according to claim 3,
wherein the diagnosing a state of the pipe includes updating the model based on a calculated thinning state of the pipe and determining a thinning risk based on a conductance value calculated from the updated model and a threshold determined based on a conductance value at a time of pipe replacement.

5. The method according to claim 1,
wherein a computer executes announcing information on operation for the pipe based on a state of the pipe.

6. A device of diagnosing a pipe, the device comprising:
a memory; and
a processor coupled to the memory and configured to:
diagnose a state of a pipe from an updated model based on change in temperature of the pipe calculated from the model in a case where the pipe is heated in the model obtained by modeling a heat transfer behavior of an inside of the pipe containing deposition by using an equivalent circuit and change in temperature of the pipe measured in a case where the pipe is heated.

7. The device according to claim 6,
wherein the model includes fluid flowing inside the pipe, deposition deposited inside the pipe, and an element representing the pipe, and
the processor calculates a state of deposition deposited inside the pipe based on a delay time between a time at a peak value in a cycle of change in temperature of the pipe calculated from the model in a case where the pipe is periodically heated and a time at a peak value in a cycle of change in measured temperature of the pipe.

8. The device according to claim 7,
wherein the processor updates the model based on a calculated state of deposition deposited in the pipe, and calculates a thinning state of the pipe based on a peak value of surface temperature of the pipe calculated from the updated model in a case where the pipe is periodically heated and a peak value of measured surface temperature of the pipe.

9. The device according to claim 8, wherein the processor updates the model based on a calculated thinning state of the pipe and determines a thinning risk based on a conductance value calculated from the updated model and a threshold determined based on a conductance value at a time of pipe replacement in the diagnosing a state of the pipe.

10. The device according to claim 6, wherein the processor announces information on operation for the pipe based on a state of the pipe.

11. A system of diagnosing a pipe, the system comprising:
a heating device that heats a pipe;
a measurement device that measures surface temperature of the pipe; and
a processor that diagnoses a state of a pipe from an updated model based on change in temperature of the pipe calculated from the model in a case where the pipe is heated in the model obtained by modeling a heat transfer behavior of an inside of the pipe containing deposition by using an equivalent circuit and change in temperature of the pipe measured in a case where the pipe is heated.
